(19) United States
(12) Patent Application Publication
(10) Pub. No.: US 2022/0294346 A1
(43) Pub. Date: Sep. 15, 2022

(54) A SWITCHED POWER CONVERTER FOR CONVERTING A DC SUPPLY VOLTAGE TO MULTIPLE BALANCED DC OUTPUT VOLTAGES

(71) Applicant: SIGNIFY HOLDING B.V., EINDHOVEN (NL)

(72) Inventor: Ulrich BOEKE, LANGERWEHE (DE)

(21) Appl. No.: 17/635,041

(22) PCT Filed: Aug. 11, 2020
(86) PCT No.: PCT/EP2020/072459

§ 371 Date: Feb. 14, 2022

(30) Foreign Application Priority Data
Aug. 19, 2019 (EP) 19192336.6

(51) Int. Cl. H02M 3/158; H02M 3/06; H05B 45/3725

(52) U.S. Cl. CPC H02M 3/158; H02M 3/06; H05B 45/3725

(57) ABSTRACT

An electrically switched power converter (10) for converting a direct current (DC) supply voltage (Vin) into at least three balanced DC output load voltages (V1, V2, . . . , Vn). The power converter (10) comprises a switching network (12) having a plurality of series connected electrically controllable switches (S1, S2, . . . , Sn). An output network (11) having a plurality of series connected capacitors (C1, C2, . . . , Cn) for providing said DC output load voltages. A plurality of inductors (L1, L2, . . . , Ln−1), and an electronic controller (14). The electronic controller (14) operates the switches of the switching network (12) for balancing the output load voltages (V1, V2, . . . , Vn) within a range of output load voltages based on a measured representation of the output load voltages and/or output load currents (Io₁, Io₂, . . . , Ioₙ), by forming respective parallel connections of capacitors (C1, C2, . . . , Cn) and inductors (L1, L2, . . . , Ln−1).

### TECHNICAL FIELD

The present disclosure generally relates to electrical power conversion and, more specifically, to a switched power converter that is arranged for converting a direct current, DC, supply voltage to multiple balanced DC output voltages.

### BACKGROUND

Lighting arrangements, such as luminaires with Light Emitting Diode, LED, or fluorescent light sources for industrial use and in the home are generally designed and specified to directly operate from mains voltage, such as a 220-230V rated alternating current, AC, mains voltage, as well as from a 220V DC voltage, for example.

In practice, industrial sites or the like may be equipped with power systems having a 650V rated DC power supply, such as emergency power battery systems, for example.

For powering, from such 650V DC power systems, electric loads having a rated DC operating voltage of 220V or 230V, for example, a power converter is required, to convert the higher supply voltage of the power system to the rated operating voltage of the electric loads, in particular, for powering three or more electric loads.

An electronic module generally known as balance converter is capable of subdividing a DC input or supply voltage into two electrically series operated DC output voltages. Such a balance converter, when used for converting a rated 650V DC voltage into two DC supply voltages for operating 220 Volt rated loads, will produce a first output voltage of 220V DC and a second output voltage of 430V DC. Operation of such a balance converter puts restrictions on the powering of balanced and unbalanced loads.

In case of powering balanced loads only, that are loads drawing equal or substantially equal operating currents and having a rated or nominal DC operating voltage lower than a given DC supply voltage, there is a need for a power converter that is able to convert the DC supply voltage into at least three balanced DC output voltages having a voltage level lower than the DC supply voltage.

### SUMMARY OF THE DISCLOSURE

The above mentioned and other objectives are solved, in a first aspect of the present disclosure, by an electrically switched power converter for converting a direct current, DC, supply voltage into a number of n balanced DC output load voltages, the electrically switched power converter comprising first and second input terminals for supplying the DC supply voltage, a switching network, an output network providing the number of output load voltages, a plurality of inductors, and an electronic controller,

the switching network comprising a plurality of series connected electrically controllable switches, the series connection having first and second switching network end terminals and a number of n−1 intermediate nodes arranged between each pair of adjacent series connected switches, the first switching network end terminal being connected to the first input terminal and the second switching network end terminal being connected to the second input terminal,

the output network comprising a capacitor network having a plurality of series connected capacitors, the series connection having first and second capacitor network end terminals and a number of n−1 intermediate nodes arranged between each pair of adjacent series connected capacitors, the first capacitor network end terminal being connected to the first input terminal and the second capacitor network end terminal being connected to the second input terminal,

the output network further comprising a plurality of pairs of output terminals connected across the capacitors of the capacitor network providing the number of output load voltages,

wherein an inductor connects between an intermediate node of the switching network and an intermediate node of the capacitor network, and

the electronic controller is arranged for operating the switches of the switching network for balancing the number of DC output load voltages within a range of output voltages based on at least one of a representation of output load voltages and output load currents, wherein n is an integer equal to or larger than 3.

In use, with the electrically switched power converter according to the present disclosure, a deviation in the rated operating power drawn by a respective load connected to a respective pair of output terminals is effectively accommodated by balancing the output load voltages of the power converter within a range of output voltages at which a respective load may operate, by establishing parallel circuits of capacitors and inductors by suitable ON and OFF switching of respective switches of the switching network, under the control of the electronic controller.

In the present description, a switch is switched ON when the switch is in a current conducting state. Otherwise, when switched OFF, the switch is a non-conducting state, i.e. no operational current is able to flow through the switch.

The switches are operated in response to representations of the output load voltages and/or output load currents, in particular in response to deviations or variations in the representations of output load voltages and/or output load currents. That is, deviations or variations amongst respective output load voltages and output load currents as well as deviations or variations in a particular output load voltage and/or output load current.

The rated power of the switched power converter according to the present disclosure is relatively small compared to prior art converters, as the present power converter processes only the difference of the rated power of the connected loads, each made up of, for example, of a plurality of LED luminaires connected in parallel, which is a strong benefit in terms of reducing overall power consumption and hence operational costs.

Moreover, the switched power converter of the present disclosure is of a relatively simple topology comprising readily available electronic devices and components, such as controllable switches, capacitors and inductors, which also attributes to circuit cost reduction.

The switching network may be comprised of a single branch of series connected switches. However, in an alternative embodiment of the present disclosure, the switching network comprises multiple branches of pairs of series connected electrically controllable switches, wherein the branches electrically connect in parallel between the first and second switching network end terminals.

Although a single branch of series connected switches is most cost effective in terms of the number of switches and control outputs of the electronic controller required, the multiple branch switching network provides for independent control of inductor currents.

Output load voltages and output load currents may be directly measured, by the electronic controller, at the respective pairs of output terminals of the power converter, for example.

In an embodiment of the present disclosure is the electronic controller arranged for obtaining the representation of output load voltages from voltages measured between the first and second capacitor network end terminals and voltages measured between an intermediate node of the capacitor network and the second capacitor network end terminal.

The respective output load voltages of the power converter can be easily calculated form measuring the voltage level at a respective output terminal with respective to a particular end terminal of the capacitor network, such as a grounded end terminal.

According to a further embodiment of the present disclosure, representations of output load currents are obtained by the electronic controller from currents measured in the plurality of inductors. The inductor currents can be measured by series connection of an accurately known resistance in series with the inductor, to create a voltage proportional to the current flow, for example.

The electronic controller is arranged for converting the measured representations, i.e. fluctuations in the measured representations of the load voltages and/or load currents into respective control signals for operating the switches of the switching network in accordance with a respective switching frequency and duty cycle.

In practice, the power converter according to the present disclosure may be operated with switching frequencies of 1 kHz and higher, allowing the output load voltages to be balanced in an essentially real time manner.

In an embodiment of the present disclosure, the electrically controllable switches comprise power semiconductor devices, in particular at least one of Metal Oxide Semiconductor Field Effect Transistor, MOSFET, Insulated Gate Bipolar Transistor, IGBT, Silicon Controlled Rectifier, SCR, Gate Turn-off Thyristor, GTO, and MOS controlled Thyristor, MCT, semiconductor devices.

According to an embodiment of the present disclosure, the electronic controller is at least one of a microcontroller, microprocessor and a Field Programmable Gate Array, FPGA.

In an embodiment of the power converter according to the present disclosure the capacitors of the capacitor network comprise equally dimensioned capacitance values and/or the inductors comprise equally dimensioned inductance values.

A capacitor network comprised of capacitors of equal capacitance provides equal output load voltages at the pairs of output terminals across a respective capacitor, assuming ideal, i.e. lossless, circuit components. In practice some minor differences in the output load voltages will occur which, however, can be balanced by suitable operation of the switching network of the power converter.

It is noted that the electrically switched power converting according to the present disclosure is not limited to a capacitor network comprised of equally dimensioned capacitors.

In a second aspect of the present disclosure, there is provided a method of operating an electrically switched power converter as disclosed above, wherein the switches of a switching network are turned ON and OFF by the electronic controller in accordance with a plurality of predefined operating modes, wherein a respective operating mode is selected by the electronic controller based on at least one of a measured representation of output load voltages and output load currents.

It will be appreciated that each operating mode is expressed by a particular setting or state, i.e. ON or OFF, of the switches of the switching network. A setting or mode wherein a direct current path is formed between the end terminals of the switching network is forbidden, as this results in short-circuiting of an input power source.

In a third aspect of the present disclosure, there is provided a lighting arrangement, comprising a plurality of lighting modules and an electrically switched power converter according to any of the previous claims, wherein between each pair of output terminals of the electrically switched power converter at least one lighting module connects.

It will be appreciated that several lighting modules may electrically connect in parallel to a pair of end terminals, provided that the parallel connected loads draw substantially equal currents from each pair of output terminals.

In an embodiment, a lighting arrangement is provided, wherein the electrically switched power converter is arranged for converting a rated 650 Volt direct current, DC, supply voltage into three balanced DC output load voltages, for powering 220 Volt DC rated load balanced lighting modules, in particular Light Emitting Diode, LED, modules. LED lighting modules with 220 Volt DC rated voltage have typically an input voltage range of 186 Volt DC-250 Volt DC.

In a fifth aspect of the present disclosure, there is provided a computer program product comprising a computer readable medium storing instructions which, when loaded on a processing device of an electronic controller of an electrically switched power converter according to the first and third aspect of the present disclosure, cause the electrically switched power converter to execute a method according to the second aspect of the present disclosure.

These and other aspects of the disclosure will be apparent from and elucidated with reference to the embodiment(s) described hereinafter.

### BRIEF DESCRIPTION OF THE DRAWINGS

FIG. 1 illustrates, in a schematic circuit diagram, a general embodiment of an electrically switched power converter according to the present disclosure.

FIG. 2 illustrates a schematic circuit diagram of a switched power converter for converting an input DC supply voltage into three series connected DC supply voltages, according to an embodiment of the present disclosure.

FIG. 3 illustrates a schematic circuit diagram of a switched power converter for converting an input DC supply voltage into three series connected DC supply voltages, according to another embodiment of the present disclosure.

FIG. 4 illustrates, in a flow chart type diagram, a method of operating a switched power converter according to the present disclosure.

FIG. 5 illustrates, schematically, a circuit diagram of an embodiment of a lighting arrangement comprising a switched power converter according to the present disclosure.

### DETAILED DESCRIPTION

A detailed description of the drawings and figures is presented in the following. It is noted that similar reference numerals in the different figures indicate same or functionally similar components or variants thereof.

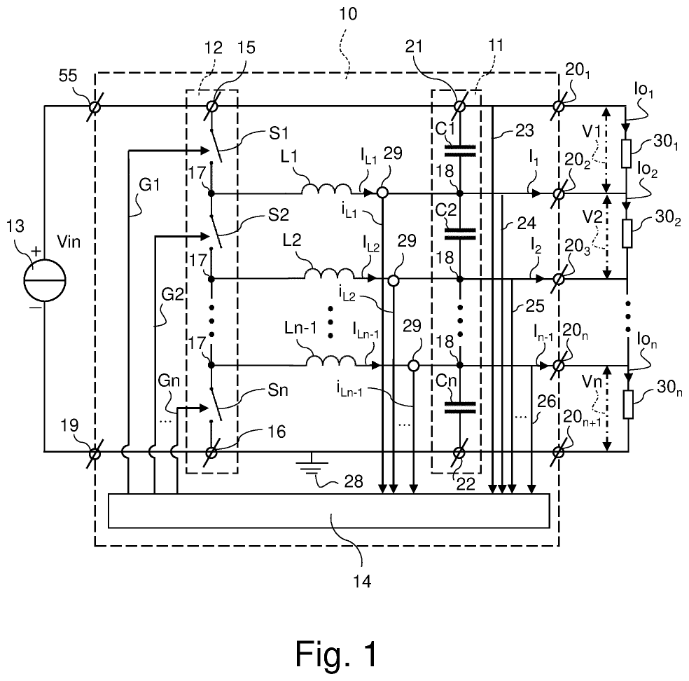

FIG. 1 illustrates a schematic circuit diagram of an electrically switched power converter 10 according to the present disclosure.

The electrically switched power convertor 10 of FIG. 1 is designed to converter a direct current, DC, input supply voltage Vin into a number of n balanced series connected DC output load voltages V1, V2, . . . , Vn. In the description and the claims, n represents an integer larger than 2. The output load voltages are used to power a plurality of balanced loads 30₁, 30₂, . . . , 30ₙ, for example a group of luminaries, that is luminaries specified to operate within a particular voltage range lower than the input supply voltage.

The electrically switched power converter 10 comprises first 55 and second 19 input terminals for connecting a DC supply voltage 13 providing the DC input voltage Vin, a switching network 12, an output network 11 providing the number of DC output load voltages, a plurality of inductors L1, L2, . . . , Ln−1, and an electronic controller 14.

The output network 11 comprises a capacitor network comprised of a plurality of series connected capacitors C1, C2, . . . , Cn. The series connection of capacitors has a first 21 and a second 22 capacitor network end terminal, and a number of n−1 intermediate nodes 18 arranged between each pair of adjacent or neighbouring capacitors in the series connection. The first capacitor network end terminal 21 connects to the first input terminal 55, and the second capacitor network end terminal 22 connects to the second input terminal 19. It will be appreciated by those skilled in the art that each of the plurality of capacitors may comprise one or more capacitances connected in series and/or parallel operating as a respective capacitor of the output network 11.

Each of the plurality of output load voltages V1, V2, . . . Vn is provided at a pair of output terminals 20₁, 20₂, . . . , 20ₙ, 20ₙ₊₁, that is a pair of output terminals across a respective capacitor C1, C2, . . . , Cn of the output network 11. As an example, the output load voltage V1 is a voltage across the capacitor C1 and provided at the output terminals 20₁ and 20₂. Or in general, output load voltage Vn is provided across the capacitor Cn between the output terminals 20ₙ and 20ₙ₊₁.

The switching network 12 comprises a plurality of series connected electrically controllable switches S1, S2, . . . , Sn. The series connection has a first 15 and a second switching network end terminals, and a number of n−1 intermediate nodes 17 in between each pair of adjacent or neighbouring switches in the series connection. The first switching network end terminal 15 connects to the first input terminal 55, and the second switching network end terminal 16 connects to the second input terminal 19.

An inductor of the plurality of inductors L1, L2, . . . , Ln−1 connects between a respective intermediate node 17 of the switching network 12 and a respective intermediate node 18 of the output network 11. It will be appreciated by those skilled in the art that each of the plurality of inductors may comprise one or more coils connected in series and/or parallel and operating as a respective inductor connecting between a respective intermediate node 17 of the switching network 12 and a respective intermediate node 18 of the output network 11.

As an example, inductor L1 electrically connects the intermediate node 17 between the pair of adjacent series connected switches S1 and S2 with the intermediate node 18 between the pair of adjacent series connected capacitors C1 and C2. Or in general, inductor Ln−1 electrically connects the intermediate node 17 between the pair of switches Sn−1 and Sn with the intermediate node 18 between the pair of capacitors Cn−1 and Cn.

The individual switches S1, S2, . . . , Sn of the switching network 12 are operated under the control of the control network 14, through respective control lines G1, G2, . . . , Gn, respectively. Via these control lines the individual switches are switched ON, i.e. in an operational state in which electrical current may flow through the switch, and switched OFF into in a non-conducting operational state.

In practice, the output load voltages V1, V2, . . . , Vn are controlled by repeatedly switching ON and OFF of one or more of the series connected controllable switches S1, S2, . . . , Sn by which one or more of the inductors L1, L2, . . . , Ln−1 are electrically parallel connected to one or more of the capacitors C1, C2, . . . , Cn.

From the general circuit diagram shown, one skilled in the art will appreciate that, dependent on the state of the particular switches, individual inductors and series connections of inductors may be switched in parallel with individual capacitors, thereby creating additional current paths in the circuit controlling respective output load currents Io₁, Io₂, . . . , Ioₙ and the amount of electrical charge stored in the capacitors C1, C2, . . . , Cn of the capacitor network, hence balancing the output load voltages V1, V2, . . . , Vn.

In the embodiment of the electrically switched power converter 10, the switches of the switching network 12 are controlled based on voltage measurements at the respective output terminals 20₁, 20₂, 20ₙ₋₁ with respect to circuit ground level 28, i.e. the second input terminal 19, by voltage measurement lines 23, 24, 25, 26 input into the controller 14, which voltages are representative of the output load voltages V1, V2, . . . , Vn. A representation of the output load currents Io₁, Io₂, . . . , Ioₙ, i.e. a difference I₁, I₂, . . . , Iₙ₋₁ between the respective output load currents Io₁, Io₂, . . . , Ioₙ, for controlling the switching network 12 by the controller 14 is obtained by measuring the inductor currents IL₁, IL₂, . . . , ILₙ₋₁ using current measurement devices 29, such as a low ohmic resistance series connected with a respective inductor.

The thus obtained inductor currents are input to the controller 14 by current measurement lines i_{L1}, i_{L2}, . . . , i_{Ln-1}. Note that the inductor currents may flow in either direction, dependent on whether a respective output load current is higher or lower compared to its rated value.

The electronic controller 14 is arranged for converting the measured output load voltages and output load currents representations for operating the switches of the switching network in accordance with a respective switching frequency and duty cycle, in response to deviations or variations in the representations of the output load voltages and/or output load currents. That is, deviations or variations amongst respective output load voltages and output load currents as well as deviations or variations in a particular output load voltage and/or output load current.

In practice, the power converter according to the present disclosure may be operated with switching frequencies of 1 kHz and higher, allowing the output load voltages to be balanced in an essentially real time manner.

According to an embodiment of the present disclosure, the electronic controller is at least one of and/or comprises a microcontroller, microprocessor and a Field Programmable Gate Array, FPGA.

In an embodiment of the present disclosure, the electrically controllable switches may comprise power semiconductor devices, in particular at least one of Metal Oxide Semiconductor Field Effect Transistor, MOSFET, Insulated Gate Bipolar Transistor, IGBT, Silicon Controlled Rectifier, SCR, Gate Turn-off Thyristor, GTO, and MOS controlled Thyristor, MCT, semiconductor devices, for example.

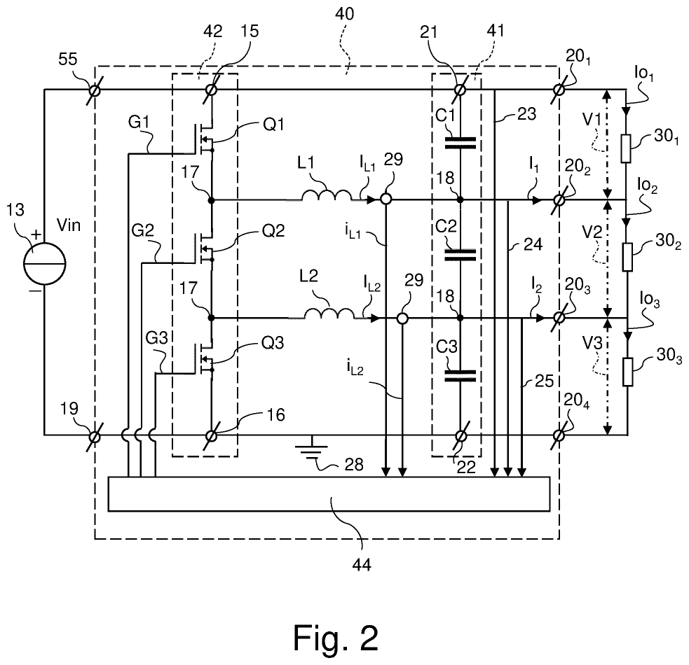

Operation of the above electrically switched power converter 10 will be described below in more detail with reference to a specific embodiment as illustrated in FIG. 2.

FIG. 2 shows a schematic circuit diagram of a switched power converter 40 for converting an input DC supply voltage Vin into three series connected DC supply voltages that typically are of equal level, according to an embodiment of the present disclosure.

In the embodiment of FIG. 2, the switching network 12 of FIG. 1 is comprised of a network 42 of three series connected power semiconductor components Q1, Q2 and Q3, operating as switches S1, S2, S3, respectively. The power semiconductor components Q1, Q2, Q3 are of the MOSFET type.

The electronic controller 44 is arranged to switch the power semiconductor components Q1, Q2 and Q3 into their ON and OFF state by a suitable drive signal at the respective gates, through the control lines G1, G2, G3, respectively, using a switching frequency of about 1 kHz and higher.

The output network 41 comprises a capacitor network of three series connected capacitors C1, C2 and C3, supplying three DC load output voltages V1, V2 and V3, across a pair of output terminal terminals, 20₁, 20₂; 20₂, 20₃; 20₃, 20₄, respectively.

In this embodiment, the three capacitors C1, C2 and C3 have an equally dimensioned capacitance value, such that the rated output load voltages V1, V2 and V3 are dimensioned to be of equal value.

The inductors L1 and L2 are likewise of an equally dimensioned inductance value.

The switched power converter 40 may be referred to as a Triple Voltage Balancer, TVB, module. The TVB module 40 is designed to operate three groups of balanced loads 30₁, 30₂, 30₃.

In a practical embodiment of the TVB module 40 a rated DC input voltage Vin of 660 Volt is converted into three equally rated balanced DC output load voltages V1, V2 and V3 of 220 Volt each, for powering three balanced loads 30₁, 30₂, 30₃, such as Light Emitting Diode, LED, modules having a rated or nominal operating voltage of 220 Volt DC, and may operate within a voltage range of 186-250 Volt, for example. Each load may comprise a plurality of parallel connected luminaires, for example, provided that the loads 30₁, 30₂, 30₃ draw substantial equal operating currents Io₁, Io₂, Io₃, respectively.

In this embodiment, for powering three balanced loads of, for example, 300 Watt each, the capacitors C1, C2, C3 each comprise a capacitance value of 2.2 μF and the inductors L1 and L2 each comprise an inductance of 300 μH.

Under ideal operation conditions, wherein the power consumption of the loads is equal, the three DC output load voltages V1, V2 and V3 remain equal. However, during operation, the power consumption of a load may vary individually, and hence the output load currents Io₁, Io₂ and Io₃ may vary individually. That is, the output load currents may vary or deviate with respect to their rated value, which deviations or variations may differ per load.

A deviation in the rated operating power drawn by a respective load connected to a respective pair of output terminals is effectively accommodated by balancing the output load voltages V1, V2 and V3 of the power converter within a range of output voltages at which a respective load may operate, under the control of the electronic controller 44.

In the embodiment shown, the power semiconductor components Q1, Q2 and Q3 are controlled based on voltage measurements at the respective output terminals 20₁, 20₂ and 20₃ with respect to circuit ground level 28, i.e. the second input terminal 19. Voltage measurement lines 23 measures the sum of all the output load voltages, i.e. V1+V2+V3. Voltage measurement line 24 measures the sum of the output load voltages V2+V3, and voltage measurement line 25 measures the output load voltage V3. From these measurements, the individual output load voltages V1, V2 and V3 can be easily derived.

A representation of the output load currents, i.e. a representation of a difference I₁, I₂ between the output load currents Io₁, Io₂ and Io₃ is obtained by the electronic controller 44 from measuring the inductor currents IL₁ and IL₂, flowing through the inductors L1 and L2, respectively, using current measurement devices 29 as elucidated above.

Based on the above measured feedback signals, the electronic controller calculates three control signals for turning-on and turning-off respective power semiconductors Q1, Q2 and Q3 via the control lines G1, G2 and G3. As each power semiconductor has two operating modes ON and OFF, the TVB 40 theoretically can have 2³=8 operating modes to control the electric energy provided to the output loads by balancing the three output load voltages V1, V2 and V3. Detailed operation of each operating mode is described in the following, wherein the current flow in the direction as indicated by a respective arrow in the figures is assumed to be positive, i.e. above zero. Current flow in the opposite direction as indicated by a respective arrow is assumed to be negative, i.e. below zero.

1st Operating Mode

Under this mode, all three power semiconductors Q1, Q2 and Q3 are turned-off, i.e. non-conducting. Currents I_{L1} and I_{L2} flowing through inductors L1 and L2, respectively, are zero. The three DC output load voltages V1, V2 and V3 are at their target values, that is V1=V2=V3. The three load currents Io₁, Io₂ and Io₃ are equal due to the series connection.

2nd Operating Mode

Under the second operating mode, the power semiconductor Q1 is turned-on, i.e. conducting, under the control of the signal G1, and the power semiconductors Q2 and Q3 are turned-off. As a result, the inductor L1 connects electrically parallel to the capacitor C1.

The change of the energy level of inductor L1 depends on the value of current I_{L1} when the power semiconductor Q1 is turned-on. The energy level stored in L1 is increased if I_{L1} was zero or above zero at turning-on Q1. The energy level stored in L1 is decreased if I_{L1} was below zero at turning-on Q1. The current in L2 is zero.

Hence, by connecting the inductor L1 electrically parallel to the capacitor C1 the output load voltages are balanced by reducing the output load voltage V1.

3rd Operating Mode

Under this mode, the power semiconductor Q2 is turned-on under the control of the signal G2, while the power semiconductors Q1 and Q3 are turned-off. As a result, the inductors L1 and L2 are series connected. The thus formed series connection of L1 and L2 connects electrically parallel to the capacitor C2.

The change of the energy level of inductor L1 depends on the value of current I_{L1} when the power semiconductor Q2 is turned-on. The energy level stored in L1 is increased if I_{L1} was zero or below zero at turning-on Q2. The energy level stored in L1 is decreased if I_{L1} was above zero at turning-on Q2.

The change of the energy level of inductor L2 depends on the value of current I_{L2} when the power semiconductor Q2 is turned-on. The energy level stored in L2 is increased if I_{L2} was zero or above zero at turning-on Q2. The energy level stored in L2 is decreased if I_{L2} was below than zero at turning-on Q2.

Hence, by connecting the series circuit of the inductors L1 and L2 electrically parallel to the capacitor C2 the output load voltages are balanced by reducing the output load voltage V2.

4th Operating Mode

Under this operating mode, the power semiconductor Q3 is turned-on under the control of the signal G2, while the power semiconductors Q1 and Q2 are turned-off. As a result, the inductor L2 connects electrically parallel to the capacitor C3.

The change of the energy level of inductor L2 depends on the value of current I_{L2} when the power semiconductor Q3 is turned-on. The energy level stored in L2 is increased if I_{L2} was zero or below zero at turning-on Q3. The energy level stored in L2 is decreased if I_{L2} was above zero at turning-on Q3. The current in L1 is zero.

Hence, by connecting the inductor L2 electrically parallel to the capacitor C3 the output load voltages are balanced by reducing the output load voltage V3.

5th Operating Mode

Under this mode, the power semiconductors Q1 and Q2 are turned-on under the control of the signals G1 and G2, while the power semiconductor Q3 is turned-off. As a result, the inductor L1 is connected electrically in parallel to the capacitor C1, and the inductor L2 is connected electrically in parallel to capacitor C2 series connected with the parallel circuit of L1 and C2.

The change of the energy level of inductor L1 depends on the value of current I_{L1} when the power semiconductors Q1 and Q2 are turned-on. The energy level stored in L1 is increased if I_{L1} was zero or above zero at turning-on Q1 and Q2. The energy level stored in L1 is decreased if I_{L1} was below zero at turning-on Q1 and Q2.

Such a connection balances the output load voltages by reducing both of the output load voltages V1 and V2.

In contrast to the 2nd operation mode, the current in L2 can be different from zero at the turn-on of Q1 and Q2.

The change of the energy level of inductor L2 depends on the value of current I_{L2} when the power semiconductors Q1 and Q2 are turned-on. The energy level stored in L2 is increased if I_{L2} was zero or above zero at turning-on Q1 and Q2. The energy level stored in L2 is decreased if I_{L2} was below zero at turning-on Q1 and Q2.

6th Operating Mode

Under this mode, the power semiconductors Q1 and Q3 are turned on under the control of the signals G1 and G3, while the power semiconductor Q2 is turned-off. As a result, the inductors L1 and L2 are connected electrically in parallel to the capacitors C2 and C3, respectively.

The change of the energy level of inductor L1 depends on the value of current I_{L1} when the power semiconductors Q1 and Q3 are turned-on. The energy level stored in L1 is increased if I_{L1} was zero or above zero at turning-on Q1 and Q3. The energy level stored in L1 is decreased if I_{L1} was below zero at turning-on Q1 and Q3.

The change of the energy level of inductor L2 depends on the value of current I_{L2} when the power semiconductors Q1 and Q3 are turned-on. The energy level stored in L2 is increased if I_{L2} was zero or below zero at turning-on Q1 and Q3. The energy level stored in L2 is decreased if I_{L2} was above zero at turning-on of Q1 and Q3.

Hence, such a connection balances the output load voltages by decreasing both the output load voltages V1 and V3.

7th Operating Mode

Under this mode, the power semiconductors Q2 and Q3 are turned-on under the control of the signals G2 and G3, while the power semiconductor Q1 is turned-off. As a result, the inductor L2 is connected electrically parallel to the capacitor C3, and the inductor L1 is connected electrically in parallel to capacitor C2 series connected with the parallel circuit of L2 and C3.

The change of the energy level of inductor L1 depends on the value of current I_{L1} when power semiconductors Q2 and Q3 are turned-on. The energy level stored in L1 is increased if I_{L1} was zero or below zero at turning-on Q2 and Q3. The energy level stored in L1 is decreased if I_{L1} was above zero at turning-on Q2 and Q3.

The change of the energy level of inductor L2 depends on the value of current I_{L2} when power semiconductors Q2 and Q3 are turned-on. The energy level stored in L2 is increased if I_{L2} was zero or below zero at turning-on Q2 and Q3. The energy level stored in L2 is decreased if I_{L2} was above zero at turning-on Q2 and Q3.

Such a connection balances the output load voltages by decreasing both the output load voltages V2 and V3.

8th Operating Mode

This is a forbidden operating mode, since having all three power semiconductors Q1, Q2 and Q3 switched-on will result in a short-circuit of the input voltage supplied between the switching network end terminals 15, 16 and may damage the TVB 40.

The above operating Modes 2-7 result either in an increase or a decrease of the energy levels in the two power inductors L1 and L2. To avoid an overload of a power inductor, different operation modes for balancing the respective output load voltages may be combined, such that first the average value of I_{L1} is equal to the average current value of the output load current Io₂ minus the output load current Io₁, and second the average value of I_{L2} is equal to the average current value of load current Io₃ minus load current Io₂.

The operation principle of the present disclosure is similarly applied to voltage balance modules with more than three series connected electric loads or groups of loads, as illustrated in FIG. 1.

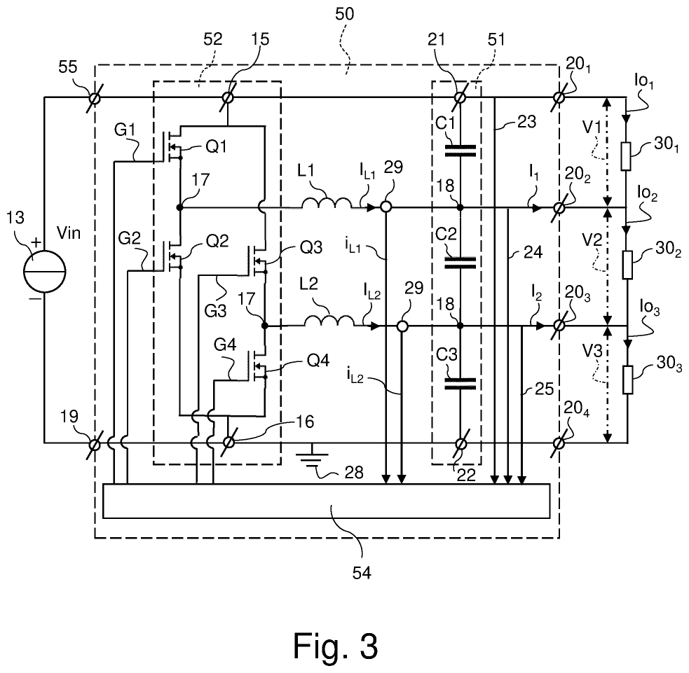

FIG. 3 illustrates a schematic circuit diagram of an alternative embodiment of an electrically switched power converter 50 for converting an input supply voltage Vin into three balanced series connected DC output voltages that typically are of equal level, according to an embodiment of the present disclosure.

The switched power converter 50 of FIG. 3 is different from the switched power converter 40 only in respect of the switching network 52. Specifically, as illustrated in FIG. 3, between the switching network end terminals 15 and 16 the switching network 52 comprises two branches of each two series connected electrically controllable switches. That is, a first branch comprised of switches Q1 and Q2, and a second branch comprised of switches Q3 and Q4. In the example of FIG. 3, each branch comprises two power semiconductors Q1, Q2 and Q3, Q4.

The capacitor network of the output network 51 may comprise a series connection of capacitors C1, C2, C3 of equally dimensioned capacitance values, in case of rated output load voltages V1, V2, V3 of equal voltage level, or of different capacitance values in case of non-equal rated output load voltages, for example.

The inductors L1 and L2 may be of equally dimensioned inductance value, or may have different inductance values, dependent on a difference in rated output load voltages. Similar considerations may apply to the power converters of FIGS. 1 and 2.

The first branch comprising the power semiconductors Q1, Q2 operates together with the first inductor L1, under the control of the electronic controller 54, to regulate the first output load voltage V1. The second branch comprising the power semiconductors Q3 and Q4 operates together with the second inductor L2, under the control of the electronic controller 54, to regulate the third output load voltage V3. The output load voltage V2 is controlled indirectly according to Kirchhoff's voltage law, that is, V2=Vin−V1−V3.

The TVB module 50 shown in FIG. 3 has the advantage that the two inductor currents I_{L1} and I_{L2} can be regulated independently.

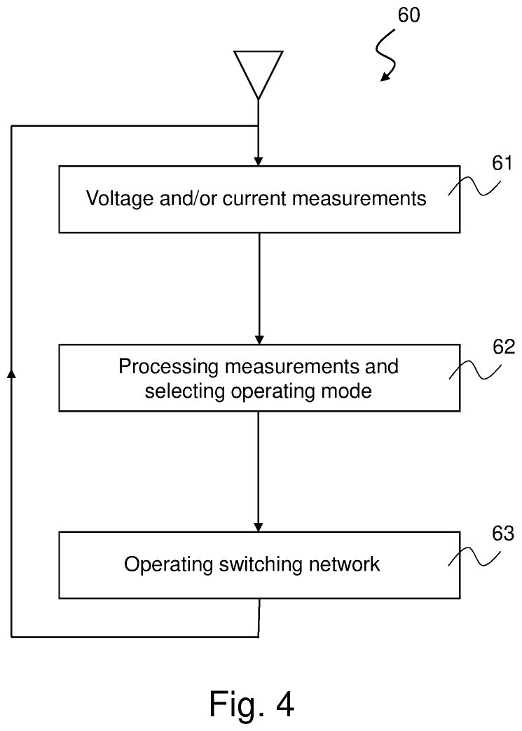

FIG. 4 illustrates, in a flow chart type diagram 60, operation of a switched power converter 10, 40, 50, 90 according to the present disclosure. The normal operational flow in the diagram runs from the top to the bottom of diagram, unless indicated otherwise by a respective arrow.

As disclosed above, the switches of the switching network 12, 42, 52 of the power converter 10, 40, 50, 90 are turned on and off by the electronic controller 14, 44, 54 through the control lines G1, G2, . . . , Gn, in accordance with a plurality of predefined operating modes. The number of operating modes depends on the number of switches in a particular switching network.

In a first step 61, “Voltage and/or current measurement” a representation of the output load voltages and/or the output load currents is measured, by the electronic controller, such as through the respective voltage measurement lines 23, 24, 25, 26 and the current measurement lines i_{L1}, i_{L2}, . . . , i_{Ln-1}, or any other suitable measurement arrangement, as elucidated above.

The respective measurements are processed by the electronic controller in step 62, “Processing measurements and selecting operating mode”, in accordance with a processing algorithm, for balancing the output load voltages, resulting in the selection of a particular operating mode. The switches of the switching network are operated in accordance with the selected operating, as illustrated by step 63, “Operating switching network”.

The switching network is operated with a respective switching frequency and duty cycle, as disclosed above, providing parallel connections of respective capacitors and inductors.

The above steps 61, 62 and 63 are continuously repeated, as indicated in the flow chart diagram 60.

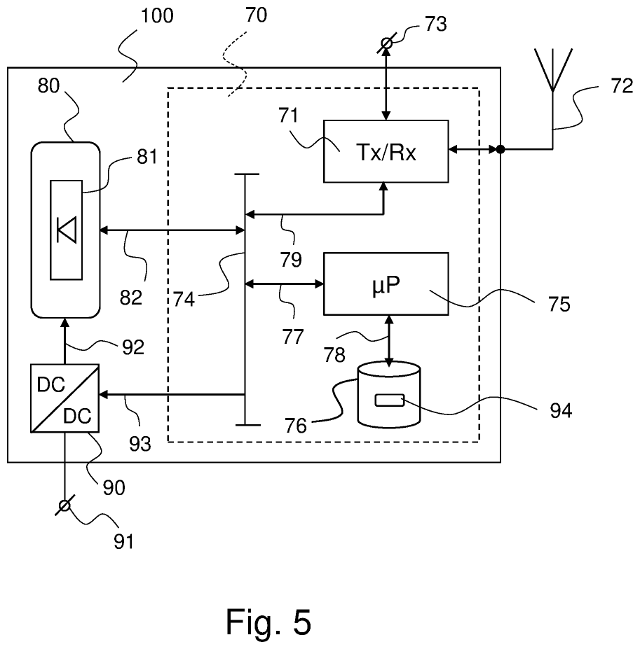

FIG. 5 illustrates, schematically, a circuit diagram of an embodiment of the lighting arrangement 100 according to the present disclosure. The lighting arrangement 100 comprises a control and communications part 70, a lighting module or lighting fixture 80 and an electrically switched power converter 90.

The control and communications part 70 comprises a transceiver, Tx/Rx, module 71 arranged for wireless 72 and/or wired 73 exchange of messages or data packets with a gateway and/or node devices, inclusive relay node devices, in a network of communicatively interconnected network node devices, such as a mesh network, for example. The transceiver 71 may be arranged to operate according to any of publicly known standardized or proprietary data communication technologies and protocols, in one or both of a broadcast and unicast mode of operation.

The control and communications part 70 further comprises at least one data processor or controller 75, and at least one data repository or storage or memory 76, among others for storing computer program code instructions for operating the lighting arrangement 100, including address information of the node device in a network, inclusive its MAC address.

The at least one processor or controller 75 communicatively interacts with and controls the lighting module or lighting fixture 80, the transceiver 71 and the at least one repository or storage 76 via an internal data communication bus 74 of the control and communications part 70, and respective control lines 77, 78, 79 and 82 as shown in FIG. 5.

The repository or storage 76 further may be arranged for storing device specific or settable time delays, repetition rates and other attributes.

The lighting module or lighting fixture 80, such as a power balanced lighting module, comprising a plurality of LED or fluorescent lighting devices 81, is electrically powered 92 by an electrically switched DC/DC power converter 90 according to the present disclosure as described above, from an external power source to be connected to an input 91 of the electrically switched DC/DC power converter 90.

The switched power converter 90 is arranged for converting a higher DC input voltage at the input 91 to multiple balanced lower DC voltages for powering the lighting fixture or lighting module 80 of the lighting arrangement 100.

The storage 76 may comprises computer code or instructions 94 which, when loaded on a processing device of the electronic controller 14, 54 of the electrically switched power converter 90, cause the electrically switched power converter 90 to balance the output voltages 92 according to the method disclosed above.

It may also be contemplated that the switched power converter may be included in a lighting system comprising multiple lighting fixtures 80 connected in parallel to each other, which are then connected to a DC supply voltage of higher voltage than the rated voltage of a single LED or fluorescent lighting device 81.

Instead of a DC input voltage, the switched power converter according to the present disclosure may comprise a rectifier input circuit (not shown) for converting an alternate current, AC, input voltage into a DC input voltage.

Other variations to the disclosed embodiments can be understood and effected by those skilled in the art in practicing the claimed disclosure, from a study of the drawings, the disclosure, and the appended claims.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope thereof.

1. An electrically switched power converter for converting a direct current, DC, supply voltage into three balanced DC output load voltages, said electrically switched power converter comprising:
first and second input terminals for supplying said DC supply voltage;
a switching network;
an output network providing three output load voltages;
two inductors; and
an electronic controller,
said switching network comprising three series connected electrically controllable switches, said series connection having first and second switching network end terminals and two intermediate nodes arranged between each pair of adjacent series connected switches, said first switching network end terminal being connected to said first input terminal and said second switching network end terminal being connected to said second input terminal,
said output network comprising a capacitor network three series connected capacitors, said series connection having first and second capacitor network end terminals and two intermediate nodes, arranged between each pair of adjacent series connected capacitors, said first capacitor network end terminal being connected to said first input terminal and said second capacitor network end terminal being connected to said second input terminal,
said output network further comprising a plurality of pairs of output terminals connected across said capacitors of said output capacitor network providing three output load voltages,
wherein, as seen from the first input terminal, a first intermediate node of the switching network is coupled to a first intermediate node of said output network by a first inductor,
a second intermediate node of the switching network is coupled to a second intermediate node of said output network by a second inductor, and
said electronic controller is arranged for operating said switches of said switching network for balancing said output load voltages within a range of output load voltages based on at least one of a representation of said output load voltages and output load currents.

2. The electrically switched power converter according to claim 1, wherein said switching network comprises n−1 multiple branches of pairs of series connected electrically controllable switches, said branches electrically connecting in parallel between said first and second switching network end terminals, wherein n is an integer larger than 3.

3. The electrically switched power converter according to claim 1, wherein said electronic controller is arranged for obtaining said representation of output load voltages from voltages measured between said first and second capacitor network end terminals and voltages measured between an intermediate node of said capacitor network and said second capacitor network end terminal.

4. The electrically switched power converter according to claim 1, wherein said electronic controller is arranged for obtaining said representation of output load currents from currents measured in said plurality of inductors.

5. The electrically switched power converter according to claim 1, wherein said electronic controller is arranged for operating said switches of said switching network based on deviations between representations of output load voltages and output load currents.

6. The electrically switched power converter according to claim 1, wherein said electronic controller is arranged for operating said switches of said switching network in accordance with a respective switching frequency and duty cycle.

7. The electrically switched power converter according to claim 1, wherein said capacitors of said capacitor network comprise equally dimensioned capacitance values.

8. The electrically switched power converter according to claim 1, wherein said inductors comprise equally dimensioned inductance values.

9. The electrically switched power converter according to claim 1, wherein said electrically controllable switches comprise power semiconductor devices, wherein the power semiconductor devices includes at least one of: a Metal Oxide Semiconductor Field Effect Transistor, a MOSFET, an Insulated Gate Bipolar Transistor, an IGBT, a Silicon Controlled Rectifier, a SCR, a Gate Turn-off Thyristor, a GTO, and a MOS controlled Thyristor (MCT) semiconductor device.

10. The electrically switched power converter according to claim 1, wherein said electronic controller comprises at least one of: a microcontroller, a microprocessor and a Field Programmable Gate Array (FPGA).

11. A lighting arrangement, comprising a plurality of lighting modules and an electrically switched power converter according to claim 1, wherein between each pair of output terminals of said electrically switched power converter at least one lighting module connects.

12. The lighting arrangement according to claim 11, wherein said electrically switched power converter is arranged for converting a rated 650 Volt direct current, DC, supply voltage into three balanced DC output load voltages, for powering 220 Volt DC rated load balanced lighting modules, in particular Light Emitting Diode, LED, modules.

13. A method of operating an electrically switched power converter according to claim 1, wherein said switches of a switching network are turned on and off by said electronic controller in accordance with a plurality of predefined operating modes, wherein a respective operating mode is selected by said electronic controller based on at least one of a measured representation of output load voltages and output load currents.

14. The method according to claim 13, wherein said operating modes comprise switching respective ones of said electrically controllable switches providing parallel connections of capacitors and inductors.

15. A computer program product comprising a non-transitory computer readable medium having instructions which, when loaded on a processing device of an electronic controller of an electrically switched power converter cause said electrically switched power converter to execute the method of claim 13.
